(19) United States
(12) Patent Application Publication
(10) Pub. No.: US 2005/0205129 A1
(43) Pub. Date: Sep. 22, 2005

(54) Method and apparatus for venting a pressure reservoir

(75) Inventors: Peter Karalis, Watertown, MA (US); Raymond A. Stacy, Framingham, MA (US); Richard Zaven Karadizian, Westford, MA (US); James E. Marquedant, Mendon, MA (US)

Correspondence Address: MERCHANT & GOULD PC, P.O. BOX 2903, MINNEAPOLIS, MN, 55402-0903, US

(73) Assignee: KIDDE-FENWAL INC., Ashland, MA (US)

(21) Appl. No.: 11/076,841

(22) Filed: Mar. 10, 2005

Related U.S. Application Data
(60) Provisional application No. 60/552,473, filed on Mar. 11, 2004.

(51) Int. Cl. F16K 17/40

(52) U.S. Cl. 137/68.13

(57) ABSTRACT

An apparatus and method for rapid fluid venting that includes a burst seal disposed in a venting aperture. The burst seal seals the venting aperture so that fluid flow therethrough is not enabled. A piston defining at least one piston aperture therethrough, the piston being movably disposed proximate the burst seal. At least one actuator, actuatable between a first configuration and a second configuration. The actuator is engaged with the piston such that when the actuator actuates from the first configuration to the second configuration, the actuator impels the piston so that the piston ruptures the burst seal. With the burst seal ruptured, the piston aperture and the venting aperture are in communication so as to enable fluid flow through the venting aperture and the piston aperture.

### CROSS REFERENCE TO RELATED APPLICATIONS

The present application draws priority from U.S. Provisional Patent Application Ser. No. 60/552,473, filed Mar. 11, 2004, and entitled “Method and Apparatus for Rapidly Venting Fluid”, which is in its entirety incorporated herewith by reference.

### FIELD OF INVENTION

The invention relates to an apparatus and method for venting fluid. More particularly, the invention relates to an apparatus and method for rapidly initiating the venting of fluid, and for rapidly venting that fluid once initiated.

### BACKGROUND OF INVENTION

A variety of venting mechanisms are known for relieving pressure and/or moving fluid from one volume to another. For example, conventional approaches may use check valves, Schrader valves, etc. However, these approaches may be relatively slow, both in terms of the time required to begin venting, and in terms of the rate at which fluid may be vented. In addition, typically as valves increase in size, the traverse distance for opening or closing the valve also increases, and consequently the time to open or close the valve increases.

This may be of concern, since some devices require a fluid to be vented before they can carry out their intended function. For example, fire suppression systems may require venting of a chamber in order to change a pressure differential that initiates dispersal of a fire suppressant. In certain applications, including but not limited to the aforementioned fire suppression, those devices may be called upon to function very rapidly and on very short notice. For example, it may be preferable to disperse fire suppressant as soon as conditions indicative of a fire are detected.

### SUMMARY OF THE INVENTION

It is the purpose of the present invention to overcome these difficulties, thereby providing an improved apparatus and method for venting fluid.

An exemplary embodiment of an apparatus for rapid fluid venting in accordance with the principles of the present invention includes a burst seal disposed in a venting aperture, such that the burst seal seals the venting aperture so that fluid flow therethrough is not enabled.

The invention also includes a rupture piston defining at least one piston aperture therethrough. The rupture piston is movably disposed proximate the burst seal.

The invention further includes at least one actuator, actuatable between a first configuration and a second configuration. The actuator is engaged with the rupture piston such that when the actuator actuates from the first configuration to the second configuration, the actuator impels the rupture piston toward the burst seal so that the rupture piston ruptures the burst seal. Thereby, with said burst seal ruptured, the piston aperture and the venting aperture are in communication so as to enable fluid flow through the venting aperture and the piston aperture.

The actuator may be an explosive actuator. The actuator may or may not be a Department of Transportation (DOT) classified device, whether or not the actuator is an explosive actuator.

In yet another exemplary embodiment, a leading edge of the rupture piston may have a cross shape with piston apertures defined in quadrants thereof. The leading edge of the rupture piston may have a ring shape with a piston aperture defined in the center thereof.

The apparatus may vent fluid from the venting aperture within 25 milliseconds of activation. The apparatus may vent fluid from the venting aperture within 10 milliseconds of activation. The apparatus may vent fluid from the venting aperture within 5 milliseconds of activation.

An exemplary embodiment of a method for rapid fluid venting in accordance with the principles of the present invention includes disposing a burst seal in a venting aperture, such that the burst seal seals the venting aperture so that fluid flow therethrough is not enabled.

The method includes movably disposing a rupture piston proximate the burst seal, the rupture piston defining at least one piston aperture therethrough.

The method further includes disposing at least one actuator, actuatable between a first configuration and a second configuration, in engagement with the rupture piston such that when the actuator actuates from the first configuration to the second configuration, the actuator impels the rupture piston toward the burst seal so that the rupture piston ruptures the burst seal.

Thereby, with the burst seal ruptured, the piston aperture and the venting aperture are in communication so as to enable fluid flow through the venting aperture and the piston aperture.

The actuator may be an explosive actuator. The actuator may or may not be a DOT-classified device, whether or not the actuator is an explosive actuator.

The leading edge of the rupture piston may have a cross shape with piston apertures defined in quadrants thereof. The leading edge of the rupture piston may have a ring shape with a piston aperture defined in the center thereof.

Fluid venting may begin within 25 milliseconds of initiation of the method. Fluid venting may begin within 10 milliseconds of initiation of the method. Fluid venting may begin within 5 milliseconds of initiation of the method.

### BRIEF DESCRIPTION OF THE DRAWINGS

Like reference numbers generally indicate corresponding elements in the figures.

FIG. 1 illustrates in schematic form an exemplary embodiment of an apparatus for venting fluid in accordance with the principles of the present invention, with a rupture piston disposed to move opposite a direction of fluid flow, in standby mode.

FIG. 2A illustrates an exemplary embodiment of a leading edge of a rupture piston for an apparatus for venting fluid in accordance with the principles of the present invention.

FIG. 2B illustrates another exemplary embodiment of a leading edge of a rupture piston for an apparatus for venting fluid in accordance with the principles of the present invention.

FIG. 2C illustrates yet another exemplary embodiment of a leading edge of a rupture piston for an apparatus for venting fluid in accordance with the principles of the present invention.

FIG. 3 illustrates the apparatus of FIG. 1, with the burst seal ruptured.

FIG. 4 illustrates the apparatus of FIG. 1, with the rupture piston further moved.

FIG. 5 illustrates in schematic form another exemplary embodiment of an apparatus for venting fluid in accordance with the principles of the present invention, with a rupture piston disposed to move in a direction of fluid flow, in standby mode.

FIG. 6 illustrates the apparatus of FIG. 5, with the burst seal ruptured.

FIG. 7 illustrates the apparatus of FIG. 5, with the rupture piston further moved.

FIG. 8 illustrates in schematic form another exemplary embodiment of an apparatus for venting fluid in accordance with the principles of the present invention, with a secondary housing, in standby mode.

FIG. 9 illustrates in schematic form another exemplary embodiment of an apparatus for venting fluid in accordance with the principles of the present invention, with a rupture piston disposed to move transversely to a direction of fluid flow and having a cutter at the leading edge thereof, in standby mode.

FIG. 10A illustrates an exemplary embodiment of a leading edge of a rupture piston for an apparatus for venting fluid in accordance with the principles of the present invention.

FIG. 10B illustrates another exemplary embodiment of a leading edge of a rupture piston for an apparatus for venting fluid in accordance with the principles of the present invention.

FIG. 10C illustrates yet another exemplary embodiment of a leading edge of a rupture piston for an apparatus for venting fluid in accordance with the principles of the present invention.

FIG. 11 illustrates the apparatus of FIG. 9, with the burst seal ruptured.

FIG. 12 illustrates the apparatus of FIG. 10, with the rupture piston further moved.

FIG. 13 illustrates in schematic form another exemplary embodiment of an apparatus for venting fluid in accordance with the principles of the present invention, with a rupture piston disposed to move transversely to a direction of fluid flow and having a cutter extending laterally therefrom, in standby mode.

### DETAILED DESCRIPTION OF THE PREFERRED EMBODIMENT

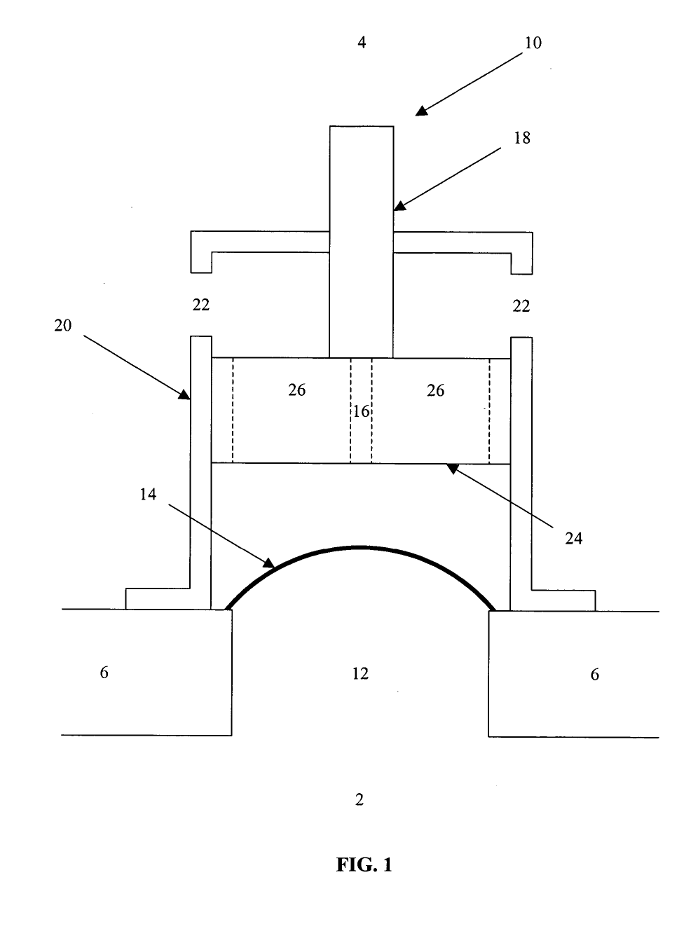

With regard to FIG. 1, an apparatus 10 for venting fluid in accordance with the principles of the present invention is shown engaged with a wall 6 of an inner volume 2 that is to be vented. With this arrangement, the inner volume 2 is to be vented to an outer volume 4. The inner and outer volumes 2 and 4 are not particularly limited. For example, the inner volume 2 may be a pressure tank, a pressurized portion of a fire extinguishing system, etc. Likewise, the outer volume 4 may be a large “ambient” space, a venting duct or pipeline, etc. The wall 6 also is not particularly limited; typically it is defined by the nature of the inner and outer volumes. However, all of the inner and outer volumes 2 and 4 and the wall 6 may vary considerably from embodiment to embodiment.

As illustrated, the apparatus 10 is in standby mode. That is, the apparatus 10 is not enabled to allow fluid venting, but may be ready to be activated so as to vent fluid. For certain embodiments, the apparatus 10 will remain in standby modes for long periods of time. For example, certain embodiments may be suitable for venting fluid in a fire extinguishing apparatus. Because fires generally are rare, the apparatus 10 may spend the great majority of its time in standby mode, without actually operating so as to vent fluid. Indeed, it may be that such an apparatus 10 is never activated to suppress a fire. For purposes of description herein, the fluid venting apparatus 10 will be considered to be for use in a fire suppression apparatus, and more particularly for use with devices that inhibit, suppress, or extinguish flames and/or explosions. However, such an arrangement is exemplary only. Other applications for the fluid venting apparatus 10 may be employed and equally suitable.

Returning to the details of the venting apparatus 10, it includes a burst seal 14. The burst seal 14 is disposed in a venting aperture 12 that is defined in the wall 6, such that the burst seal 14 seals the venting aperture 12. The venting aperture may be but is not limited to a bore-like structure or any opening giving access to, for example, a pressure reservoir and a pressure vessel conventionally known such as in fire suppression devices. The burst seals 14 need not be positioned exactly as illustrated and its position may vary, so long as the venting apparatus 10 functions as described herein. The burst seal 14 may be a metallic burst disk, such as but not limited to copper, and may be mechanically attached to the wall 6 and within the venting aperture 12. It will be appreciated, however, that the burst seal 14 may be made of other materials having physical properties satisfactory for operation of the venting apparatus 10 and which may be equally suitable. With the burst seal 14 so disposed as shown in FIG. 1, fluid flow through the venting aperture 12 is not enabled.

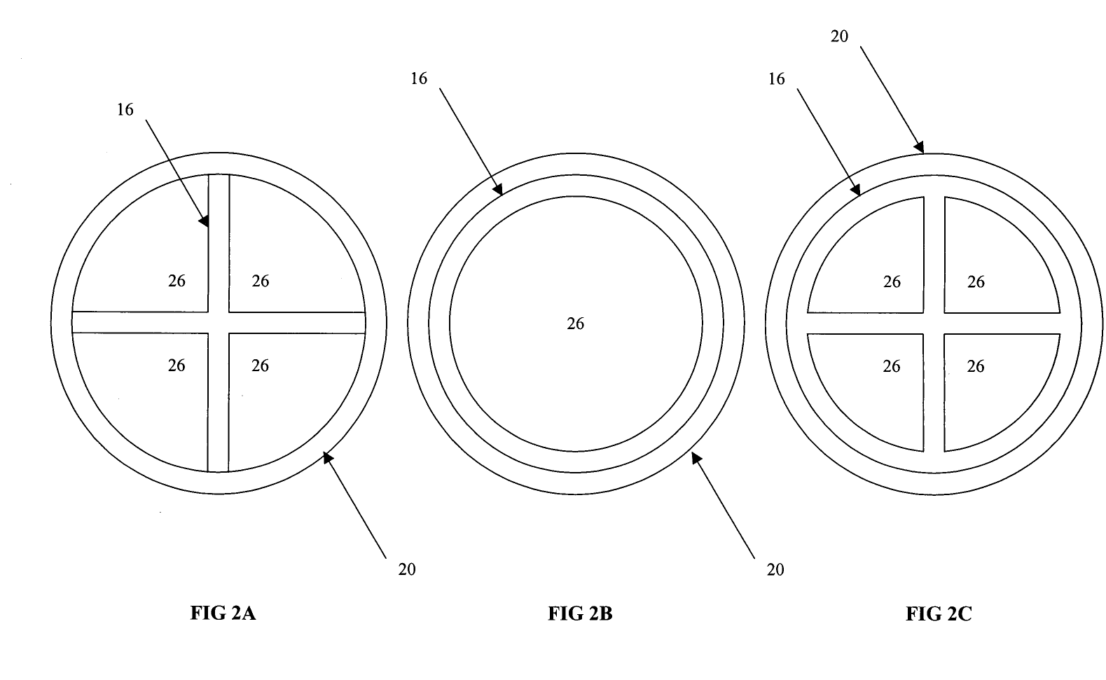

The apparatus 10 also includes a movable rupture piston 16. The rupture piston 16 is movably disposed in the vicinity of the burst seal 14. As may also be seen from FIGS. 2A-2C, the rupture piston 16 defines at least one piston aperture 26 therethrough, such that fluid flow through the rupture piston 16 is enabled via the piston aperture 26.

Returning to FIG. 1, the apparatus 10 further includes at least one actuator 18. The actuator 18 is actuatable between a first configuration and a second configuration. The actuator 18 is engaged with the rupture piston 16, as described further below.

When the apparatus 10 is in standby mode, the actuator 18 is in the first configuration, as shown in FIG. 1. The burst seal 14 is undisturbed, and fluid flow through the venting aperture 12 thus is not enabled.

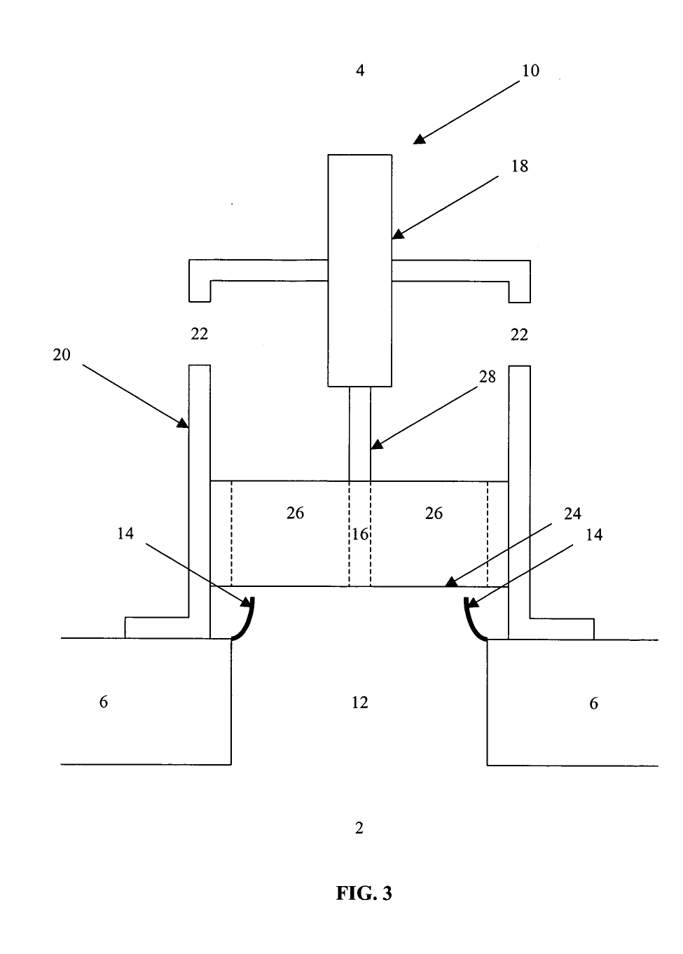

When the apparatus 10 is activated, the actuator 18 actuates towards its second configuration, as shown in FIG. 3. As illustrated therein, the actuator 18 extends an actuator piston 28 therefrom and thus impelling the rupture piston 16 toward the burst seal 14. However, this arrangement is exemplary only, and other arrangements for an extending support may be equally suitable for actuation to the second configuration and drive the rupture piston 16 toward the burst seal 14.

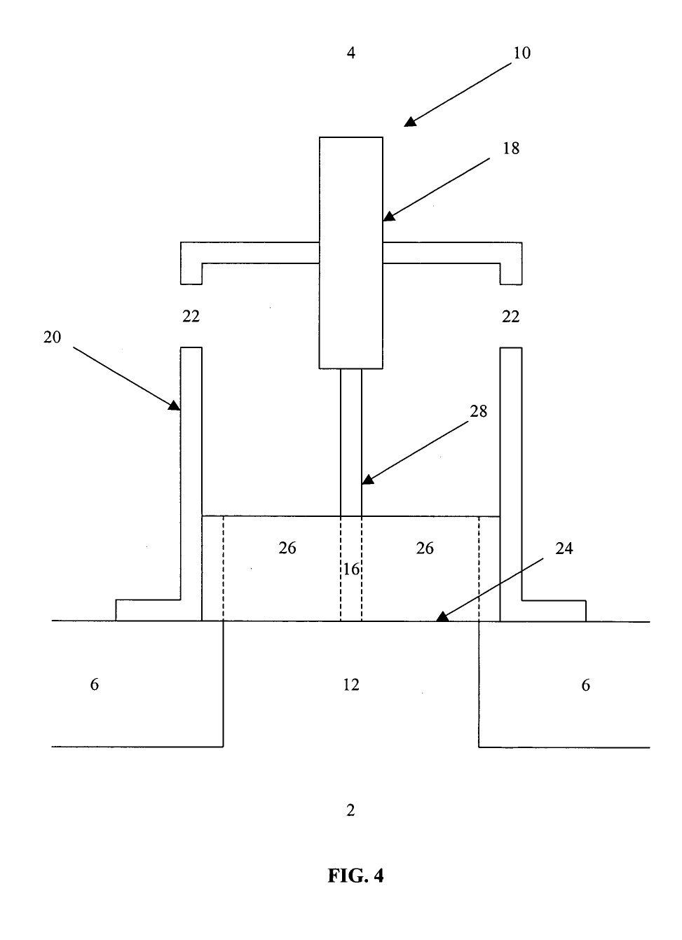

The actuator 18 is engaged with the rupture piston 16 such that as the actuator 18 actuates towards its second configuration. As shown in FIGS. 3 and 4, the actuator 18 extends the actuator piston 28, whereby the actuator 18 impels the rupture piston 16 toward the burst seal 14. Consequently, the rupture piston 16 ruptures the burst seal 14.

With the burst seal 14 ruptured, the venting aperture 12 and the piston apertures 26 are in fluid communication, so as to enable fluid flow through the venting aperture 12 and the piston apertures 26.

For purposes of clarity, the travel distance of the rupture piston 16 may be somewhat exaggerated as illustrated. The actual distance depends to at least some degree on the details of the particular embodiment, i.e. the pressure differentials of the inner and outer volumes 2, 4, the anticipated burst strength of the burst seal 14, and so forth. However, it will be appreciated that the travel distance for the rupture piston 16 may be relatively small for at least some embodiments.

The apparatus 10 may include a housing 20. The housing 20 may enclose all or part of the burst seal 14, the rupture piston 16, and/or the actuator 18. If present, a housing 20 may serve to protect the various components of the apparatus 10, and/or to help keep the apparatus 10 free of obstructions, debris, etc. However, the use of a housing 20 is exemplary only.

Embodiments of the apparatus 10 that do include a housing 20 may include housing apertures 22 to allow fluid venting through the venting aperture 12 and the piston apertures 26 to escape the housing 20.

The rupture piston 16 may include a cutter 24, for example at the leading edge of the rupture piston 16. This cutter may be sharpened, so as to facilitate rupture of the burst seal 14 by cutting action. However, this arrangement is exemplary only. A cutter 24 that is not sharp, including but not limited to one that is deliberately blunted, may be equally suitable. In addition, a cutter 24 that is not disposed at the leading edge of the rupture piston 16, may be equally suitable. Such an alternative arrangement for the cutter 24 is described elsewhere herein.

The structure of the rupture piston 16 is not particularly limited. In particular, the shape of the rupture piston 16 at the leading edge thereof may vary considerably from embodiment to embodiment. FIGS. 2A-2C show three exemplary arrangements for a cutter 24 of the leading edge of the rupture piston 16 from FIG. 1. For perspective, the leading edge is shown as though the rupture piston 16 were disposed in a cylindrical housing 20, though as previously noted the use of a housing 20 is exemplary only.

FIG. 2A illustrates a leading edge having a cross shape, with piston apertures 26 in each of the four quadrants defined thereby. FIG. 2B shows a leading edge having a circular or ring shape, with a piston aperture 26 defined in its center. FIG. 2C shows a leading edge with a combination of cross and ring structures, again defining piston apertures 26 in each of its four quadrants. However, these arrangements are exemplary only, and other arrangements may be equally suitable for constructing and arranging a leading edge.

The actuator 18 also may vary from embodiment to embodiment. In a preferred embodiment, the actuator 18 is a rapid activation actuator. In particular, it may be preferable for some embodiments that the actuator 18 actuates from its first to its second configuration in a total time of less than 25 milliseconds. In other embodiments it may be preferable that the actuator 18 actuate from its first to its second configuration in a total time of less than 10 milliseconds. In still other embodiments it may be preferable that the actuator 18 actuate from its first to its second configuration in a total time of less than 5 milliseconds.

Embodiments of the apparatus 10 including such rapid activation actuators 18 may themselves be considered rapid activation vents. Thus, for some embodiments it may be preferable that the apparatus 10 facilitates fluid flow through the venting aperture 12, that is, that the burst seal 14 is ruptured, less than 25 milliseconds after being activated. For other embodiments it may be preferable that the apparatus 10 facilitates fluid flow through the venting aperture 12 less than 10 milliseconds after being activated. For still other embodiments it may be preferable that the apparatus 10 facilitates fluid flow through the venting aperture 12 less than 5 milliseconds after being activated.

For certain embodiments, it may be preferable that the actuator 18 is an explosive actuator. In addition, for some embodiments it may be preferable that the actuator 18 is not DOT classified as an explosive device, so that DOT restrictions regarding shipment of explosive devices do not apply to the actuator 18. By employing an actuator that is not DOT-classified as an explosive device, it can be shipped through normal delivery channels, which is much more convenient for customers. However, this is exemplary only, and other arrangements may be equally suitable.

A variety of actuators 18 may be suitable for use with the apparatus 10. In particular, the METRON (TM), manufactured by Nobel Enterprises Energetic Technologies of Ayrshire, Scotland has been determined to be suitable. However, the present invention is not limited only to use with the METRON (TM), and other actuators 18 may be equally suitable.

The actuator 18, and consequently the apparatus 10, may be activated in a variety of manners. For example, the actuator 18 may be activated by an electrical signal, such as one sent by a control unit. However, this arrangement is exemplary only, and other arrangements may be equally suitable.

It is noted that the apparatus need not stop immediately upon rupturing the burst seal 14. FIG. 4 shows an arrangement wherein the rupture piston 16 has continued moving beyond the point shown in FIG. 3, so that the rupture piston 16 abuts against the edges of the venting aperture 12 of the wall 6. Thus, actuation of the actuator 18 to its second configuration, wherein the rupture piston 16 ruptures the burst seal 14, does not preclude further motion.

The burst seal 14 may vary from embodiment to embodiment. In particular, the size of the burst seal 14 may vary. For certain embodiments, it may be desirable for the burst seal 14 to be relatively large, so as to vent a large volume, and/or to vent a volume rapidly. Alternatively, the burst seal 14 may be made relatively small, for small volumes and/or low rates of venting. The apparatus 10 may be scaled appropriately. With regard to scale, it is noted that the time to rupture the burst seal 14, and thus to enable fluid flow through the venting aperture 12, generally is not strongly dependent on the diameter of the burst seal 14. Thus, the activation time of an apparatus 10 in accordance with the principles of the present invention may be substantially independent of its size.

In addition, the rupture strength, thickness, etc. of the burst seal 14 may vary. If fluid behind the burst seal 14 is under pressure, the burst seal 14 typically should have a minimum rupture strength sufficient to maintain integrity during standby given the level of that pressure. However, the rupture strength of the burst seal 14 may not otherwise be limited, and in particular may not be rated for a specific required maximum pressure. As described herein, the burst seal 14 is ruptured mechanically by the rupture piston 16. Thus, there will not necessarily be a definite relationship between the maximum rupture strength of the burst seal 14 and the fluid pressure exerted upon it, since for at least certain embodiments the rupture strength of the burst seal 14 may be made much higher than the maximum force anticipated to be exerted thereon by the fluid.

It is noted that the term “fluid” sometimes is used to denote only a liquid or a gas.

This is not the case herein. With regard to both the exemplary embodiment of the apparatus 10 for venting fluid which may be used in fire suppression devices generally, the term “fluid” is used herein in a broad sense, and should be considered to include any substance that may be made to flow. This includes, but is not limited to, liquids, gases, granular or powdered solids, foams, mixtures or emulsions of two or more fluids, suspensions of solids within liquids or gases, etc.

Thus, although liquids and gases are by no means excluded from use with a fluid venting apparatus 10 in accordance with the principles of the present invention, certain embodiments thereof may vent fluids that do not necessarily include either liquids or gases.

In addition, although for simplicity the fluid venting apparatus 10 is described herein as venting a single fluid, this is not necessarily the case. Two or more fluids may be vented, simultaneously or in sequence.

Furthermore, the fluid or fluids vented may be compressible or incompressible, or a mixture of both. The type of fluid for fire suppression suitable fluids, for example, may include but are not limited to HFC-227ea (1,1,1,2,3,3,3-Heptaflurorpropane CF₃CHFCF₃) and other hydrofluorocarbons, HALON® 1301 (bromotrifluoromethane CBrF₃), carbon dioxide (CO₂) in liquid or gaseous form, and sodium bicarbonate (NaHCO₃), H₂O, and KIDDEx®. It will be appreciated that these are only exemplary type of fluids that may be used and that other fluids with similar suppression properties may equally be desirable, including but not limited to other liquefied compressed gases, inert gases, water and dry chemical extinguishing agents. Likewise, other fluids may be employed that may or may not be designed for fire suppression applications and may be employed for other dispensing purposes.

FIGS. 1, 3, and 4 show an exemplary arrangement wherein the fluid venting apparatus 10 is disposed on the outer volume 4 side of the wall 6, arranged so that the rupture piston 16 moves inward. The rupture piston 16 is moving from the direction of the outer volume 4 side of the wall towards the direction of the inner volume 2 side of the wall 6 when it ruptures the burst seal 14.

For example, for an apparatus 10 as shown in FIGS. 1, 3, and 4, and an arrangement wherein the inner volume 2 is at high pressure and the outer volume is at low pressure, 4, the path of the rupture piston 16 is such that it ruptures the burst seal 14 from the low pressure side to the high pressure side.

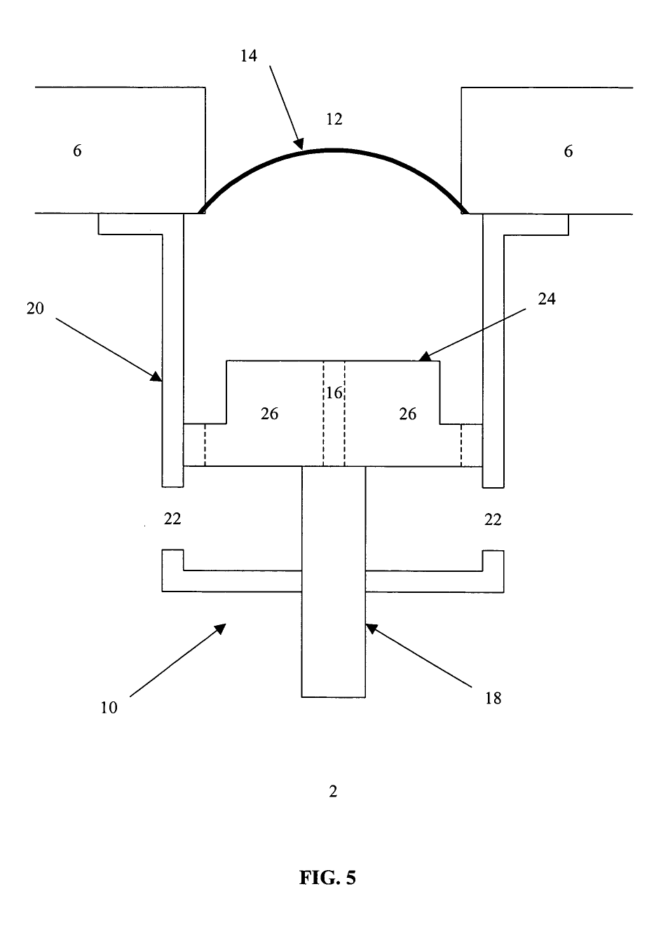

However, such an arrangement is exemplary only. Other arrangements may be equally suitable. For example, FIGS. 5-7 show an embodiment of a fluid venting apparatus 10 in accordance with the principles of the present invention wherein the rupture piston 16 moves in the opposite direction from what is shown in FIGS. 1, 3, and 4. Specifically, in FIG. 5 the fluid venting apparatus 10 is disposed on the inner volume 2 side of the wall 6, arranged so that the rupture piston 16 moves outward. Thus, in use the rupture piston 16 moves from the direction of the inner volume 2 side of the wall towards the direction of the outer volume 4 side of the wall 6 to rupture the burst seal 14.

Continuing the example presented with respect to FIGS. 1, 3, and 4, for an apparatus as shown in FIGS. 5-7 and for an arrangement wherein the inner volume 2 is at high pressure and the outer volume is at low pressure, 4, the path of the rupture piston 16 is such that it ruptures the burst seal 14 from the high pressure side to the low pressure side.

For clarity, the arrangement, operation, and components of the embodiment illustrated in FIG. 5 are shown to be similar to what is shown in FIGS. 1, 3, and 4. They may be considered to function similarly, although fluid being vented therethrough will pass through the components in a different order. For example, in the arrangement of FIGS. 1, 3, and 4 fluid being vented from the inner volume 2 when the burst seal 14 is ruptured would pass through the venting aperture 12 first, then the piston apertures 26, and then through the housing apertures 26 to reach the outer volume 4. By contrast, with the arrangement of FIGS. 5-7 fluid would pass from the inner volume 2 through the housing apertures 22, then the piston apertures 26, and then through the venting aperture 12 to reach the outer volume 4.

However, although the embodiment shown in FIGS. 5-7 is illustrated similarly to that of FIGS. 1, 3, and 4 for clarity, it is emphasized that both of these embodiments are exemplary only, and that other arrangements may be equally suitable.

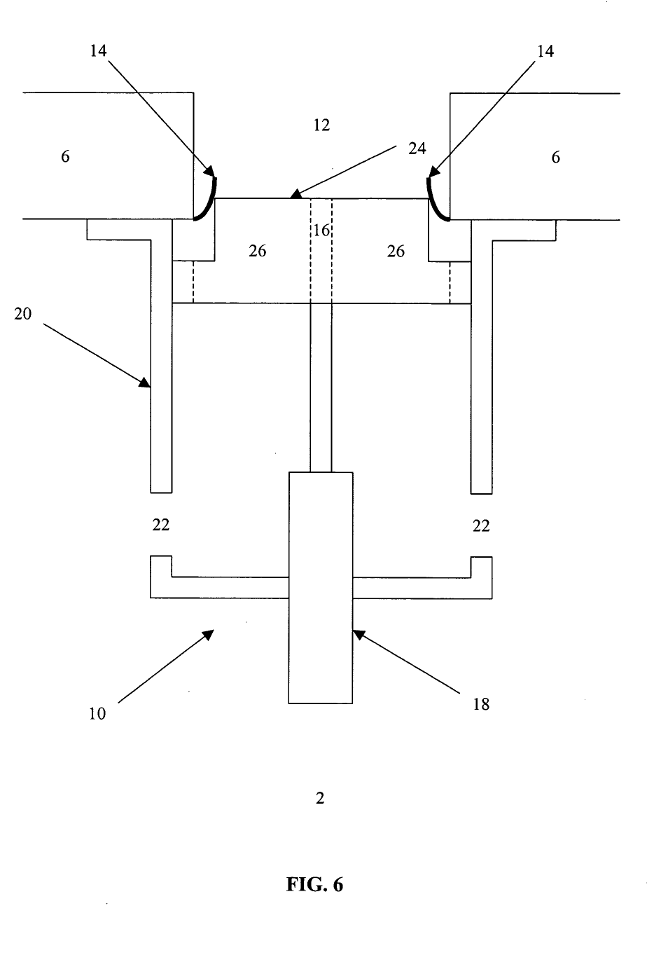

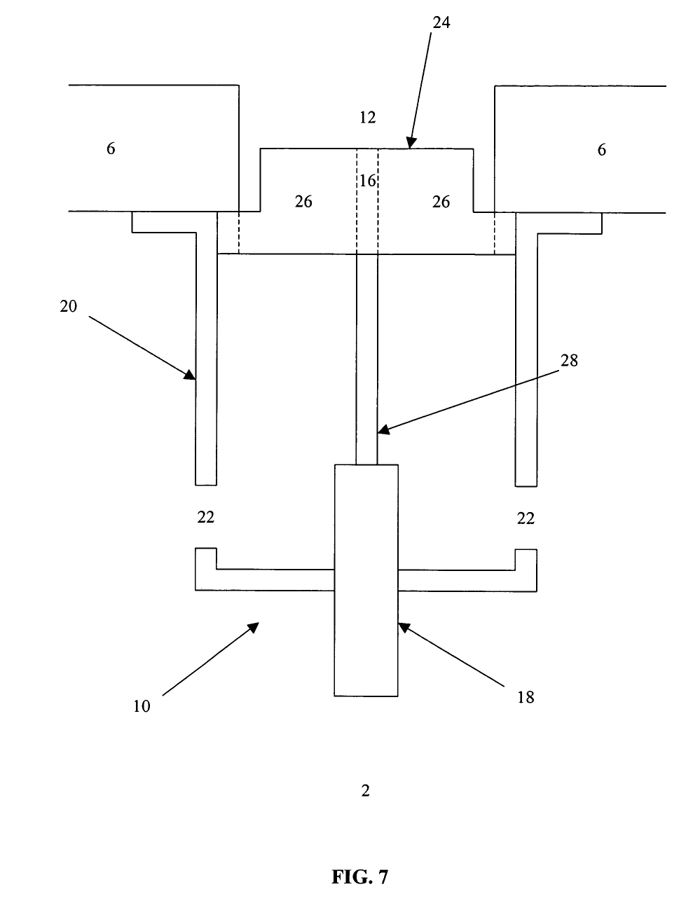

Particularly, FIG. 5 illustrates the apparatus 10 for venting fluid, with a rupture piston 16 disposed to move in a direction of fluid flow, in standby mode. Particularly, FIG. 6 illustrates the apparatus of FIG. 5, with the burst seal ruptured. Particularly, FIG. 7 illustrates the apparatus of FIG. 5, with the rupture piston further moved.

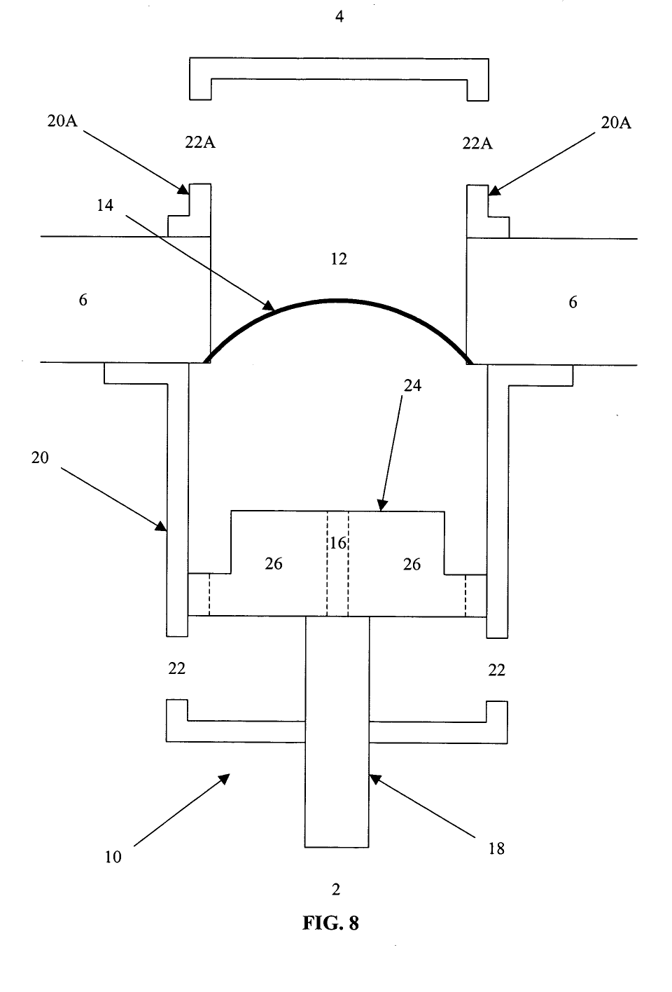

FIG. 8 shows an apparatus 10 similar to that in FIGS. 5-7, with several additional components. Referring to FIGS. 1, 3, and 4, when the housing 22 is disposed on the outer volume 4 side of the wall 6, it may be used to protect the other components of the apparatus, in particular the burst seal 14, from external damage. With an arrangement as shown in FIG. 5, wherein the apparatus is inside the inner volume 2, for example inside of a pressure vessel, it may be advantageous to provide some degree of protection on the outer side of the wall 6. FIG. 6 shows such an arrangement.

Differently from FIGS. 5-7, FIG. 8 illustrates a cover 20A disposed over the venting aperture 12. Cover apertures 22A defined in the cover 20A allow the fluid being vented to escape into the outer volume 4. The cover 20A may be any structure suitable as a secondary housing at the outer volume 4 side of the wall 6. However, such an arrangement is exemplary only. Alternative covers or protective mechanisms, or none, may be equally suitable. Particularly, FIG. 8 illustrates the apparatus 10 for venting fluid including a secondary housing, in standby mode.

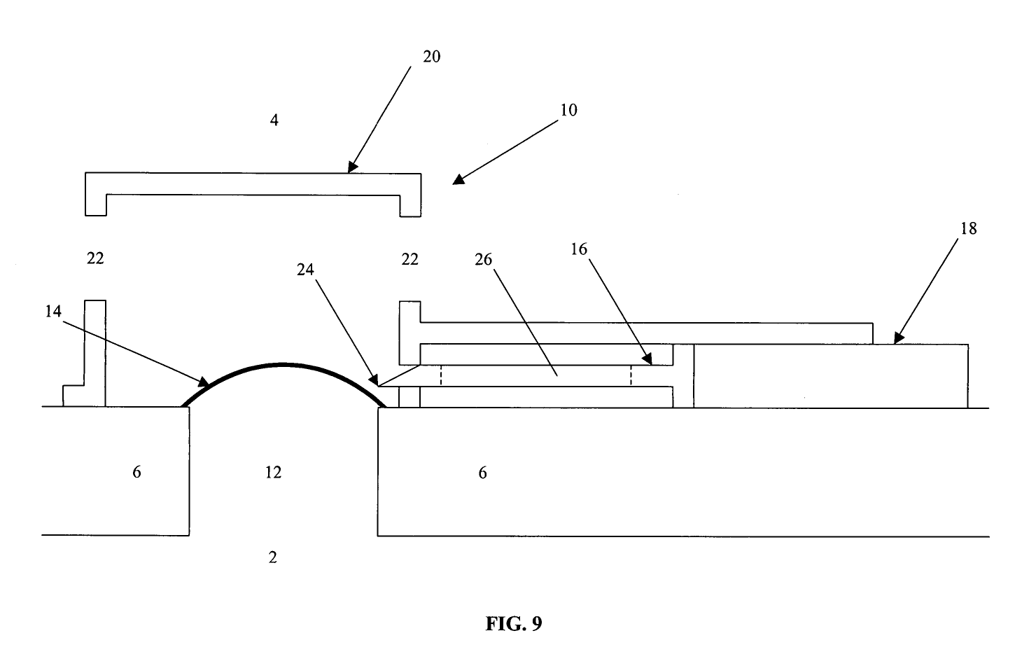

For clarity, the arrangement, operation, and components of the embodiment illustrated in FIGS. 9-12 are shown to be functionally similar to what is shown in FIGS. 1-7. Similar features are not further described.

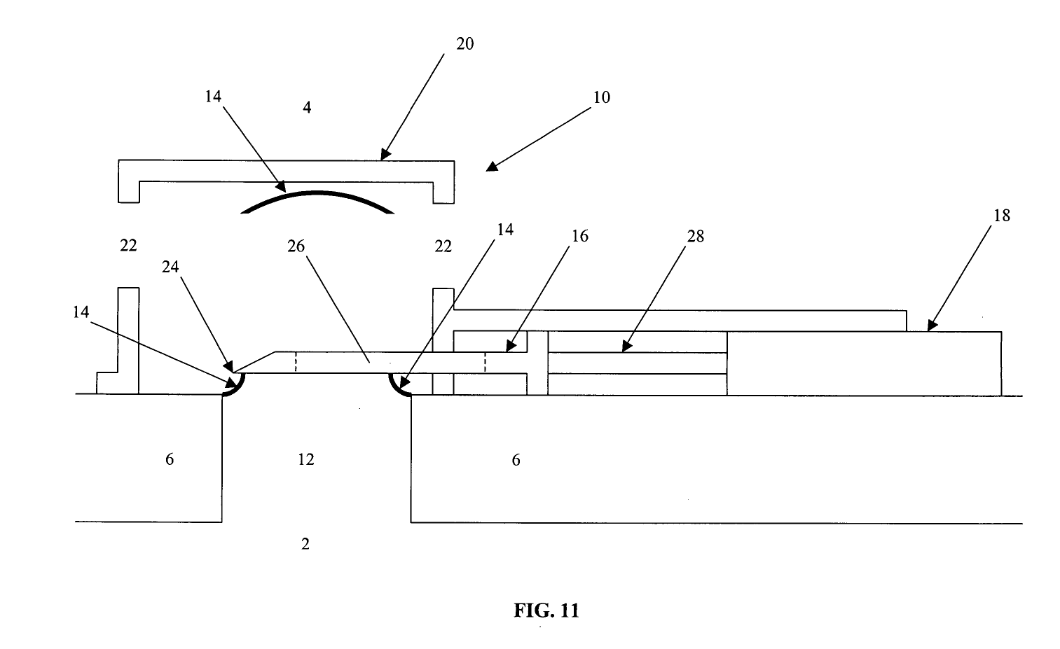

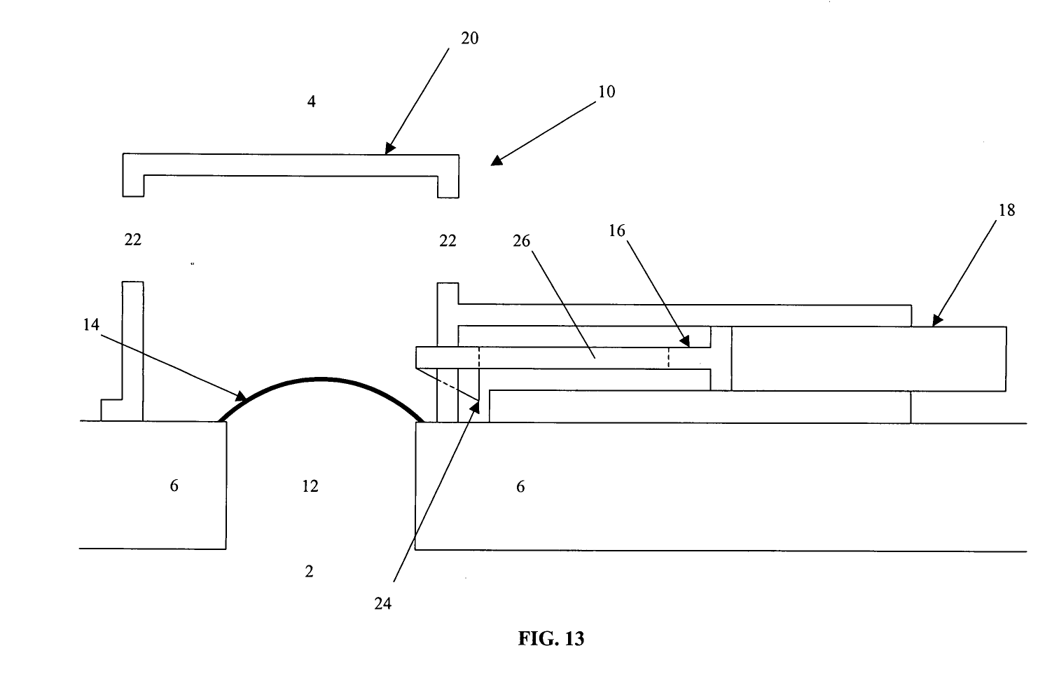

FIG. 9 shows another exemplary embodiment of an apparatus 10 for venting fluid where a rupture piston 16 disposed to move transversely to a direction of fluid flow and having a cutter 24 at the leading edge thereof. Similar to FIGS. 1, 3, and 4, when the housing 20 is disposed on the outer volume 4 side of the wall 6, it may be used to protect the other components of the apparatus, in particular the burst seal 14, from external damage. Thus, as best shown in FIG. 11 when the rupture piston 16 is actuated by the actuator 18 and actuator piston 28 from said first configuration to said second configuration, said piston may sever at least a portion of the burst seal 14 in a direction transverse to a direction of the fluid flow through the venting aperture 12. Such a transverse stroke may or may not rupture the device in practice, per se. The transverse stroke of the rupture piston 16 and cutter 24 may slice, sever, or guillotine a portion or the entire the burst seal 14 off. Additionally, in practice the cutter may slash the burst seal 14 open (further described in FIG. 13 below).

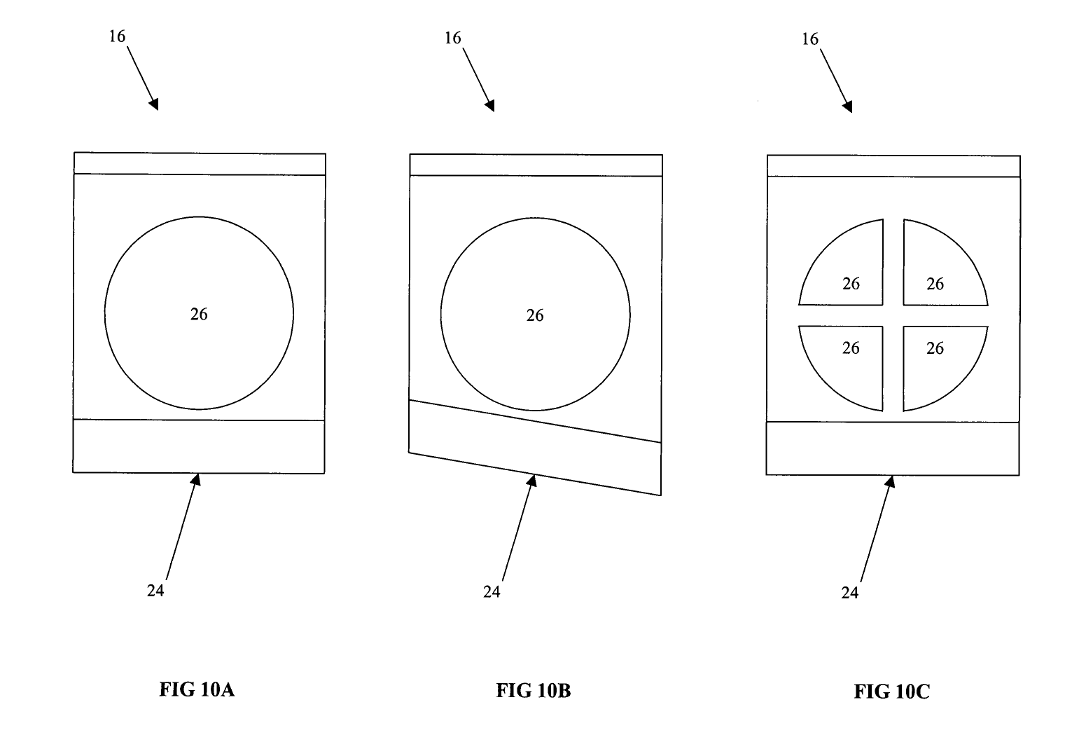

FIG. 10 illustrates exemplary embodiments for the rupture piston 16 and its leading edge with the cutter 24 thereon for the apparatus 10. The piston aperture 26 for a transverse stroke may be a hole in a direction transverse to the stroke. Thus, the piston aperture 26 may be through the shaft the short way and in contrast with the embodiment of FIGS. 1-8, where the aperture is shown through the piston in the direction of the stroke. FIG. 10A illustrates a leading edge with a cutter 24 having a tapered rectangular segment. A single piston aperture 26 is defined substantially at a center of the rupture piston 16 and trailing the leading edge. FIG. 10B shows a leading edge with a cutter 24 having a slant. The piston aperture 26 also is defined in its center and trailing the leading edge. FIG. 10C shows a leading edge with a cutter 24 similar to FIG. 10A, however defining piston apertures 26 as four quadrants. These arrangements, however, are exemplary only, and other arrangements may be equally suitable for constructing and arranging a leading edge so as to be in keeping with the principles of the present invention.

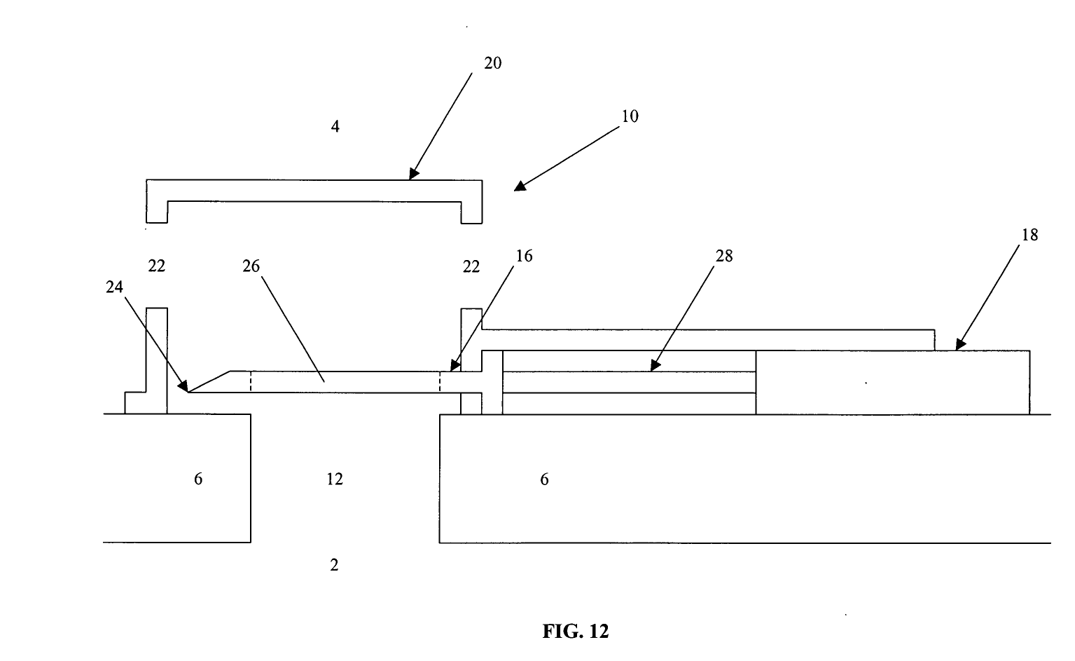

Particularly, FIG. 9 illustrates the apparatus 10 in standby mode. Particularly, FIG. 11 illustrates the apparatus 10, with the burst seal ruptured. Particularly, FIG. 12 illustrates the apparatus 10, with the rupture piston 16 further moved.

For clarity, the arrangement, operation, and components of the embodiment illustrated in FIG. 13 are shown to be functionally similar to what is shown in FIGS. 1-7. Similar features are not further described.

FIG. 13 illustrates another exemplary embodiment of an apparatus 10 for venting fluid. Similarly to FIGS. 9, 11 and 12, a rupture piston 16 is disposed to move transversely to a direction of fluid flow and having a cutter 24 extending laterally therefrom. In this embodiment, the rupture piston 16 may slash a portion of the burst seal 14 open using the transverse stroke described in FIGS. 9, 11, and 12, rather than slicing a portion off. In this configuration, the cutter 24 may resemble a cat's claw sticking out from the rupture piston 16. The rupture piston itself moves past the burst seal, and only the cutter 24 makes contact to split the seal open. The cutting action here may result to lacerate the burst seal. It will be appreciated, however, that in practice the cut may or may not necessarily be a clean cut. The cut may be a slashing or somewhat rough cut, so long as the burst seal 14 can be broken to release and vent fluid. It will further be appreciated that the rupture piston 16 may be required to transversely pass over the burst seal 14 and venting aperture 12 in order sufficiently slash open the burst seal 14 and break it open.

Particularly, FIG. 13 illustrates the apparatus 10 in standby mode. It will be appreciated that the transverse movement of the rupture piston 16 in FIG. 13 is substantially similar to FIGS. 9, 11, and 12.

It has been noted that the term “rupture” for the rupture piston has been employed in connection with a leading edge including a cutter 24 that may or may not be sharp so as to break the burst seal 14. Such actions as, but not limited to, cutting, slicing, slashing, puncturing, and rupturing describe in practice what may result in certain embodiments employing any rupture piston 16 previously described. Thus, it will be appreciated that such descriptive examples are non-limiting and simply define in practice the results when the rupture piston 16 contacts with the burst seal 14 so as to break the burst seal 14 open thereby venting and releasing fluid. It will be further appreciated that any number of breaks of the burst seal 14 may be equally suitable, so long as the apparatus 10 is vented in accordance with the principles described.

The above specification, examples and data provide a complete description of the manufacture and use of the composition of the invention. Since many embodiments of the invention can be made without departing from the spirit and scope of the invention, the invention resides in the claims hereinafter appended.

1. An apparatus for rapid fluid venting, comprising:
a burst seal disposed in a venting aperture, such that said burst seal seals said venting aperture so that fluid flow therethrough is not enabled;
a piston defining at least one piston aperture therethrough, said piston being movably disposed proximate said burst seal;
at least one actuator, actuatable between a first configuration and a second configuration;
wherein
said actuator is engaged with said piston such that when said actuator actuates from said first configuration to said second configuration, said actuator impels said piston so that said piston ruptures said burst seal;
whereby with said burst seal ruptured, said piston aperture and said venting aperture are in communication so as to enable fluid flow through said venting aperture and said piston aperture.

2. The apparatus according to claim 1, wherein:
when actuated from said first configuration to said second configuration, said piston penetrates said burst seal in a direction of said fluid flow through said aperture.

3. The apparatus according to claim 1, wherein:
when actuated from said first configuration to said second configuration, said piston penetrates said burst seal in a direction opposite a direction of said fluid flow through said aperture.

4. The apparatus according to claim 1, wherein:
when actuated from said first configuration to said second configuration, said piston severs a portion of said burst seal in a direction transverse to a direction of said fluid flow through said aperture.

5. The apparatus according to claim 1, wherein:
when actuated from said first configuration to said second configuration, said piston lacerates said burst seal in a direction transverse to a direction of said fluid flow through said aperture.

6. The apparatus according to claim 1, wherein:
said actuator is an explosive actuator.

7. The apparatus according to claim 1, wherein:
said actuator is not a DOT-classified explosive device.

8. The apparatus according to claim 1, wherein:
said piston comprises a leading edge, such that said leading edge contacts and ruptures said burst seal when said piston actuates from said first configuration to said second configuration.

9. The apparatus according to claim 8, wherein:
said leading edge having a cross shape with said piston apertures defined in quadrants thereof.

10. The apparatus according to claim 8, wherein:
leading edge having a ring shape said piston aperture defined in a center thereof.

11. The apparatus according to claim 9, wherein:
said apparatus vents fluid from said venting aperture within 25 milliseconds of activation.

12. The apparatus according to claim 1, wherein:
said apparatus vents fluid from said venting aperture within 10 milliseconds of activation.

13. The apparatus according to claim 1, wherein:
said apparatus vents fluid from said venting aperture within 5 milliseconds of activation.

14. The apparatus according to claim 1, wherein:
a travel path of said rupture piston is such that said rupture piston ruptures said burst seal from a high-pressure side of said burst seal.

15. The apparatus according to claim 1, wherein:
a travel path of said rupture piston is such that said rupture piston ruptures said burst seal from a high-pressure side of said burst seal.

16. The apparatus according to claim 1, wherein:
a travel path of said rupture piston is such that said rupture piston ruptures said burst seal from a low-pressure side of said burst seal.

17. A method for rapid fluid venting, comprising:
disposing a burst seal in a venting aperture, such that said burst seal seals said venting aperture so that fluid flow therethrough is not enabled;
movably disposing a rupture piston proximate said burst seal, said rupture piston defining at least one piston aperture therethrough;
disposing at least one actuator, actuatable between a first configuration and a second configuration, in engagement with said rupture piston such that when said actuator actuates from said first configuration to said second configuration, said actuator impels said rupture piston toward said burst seal so that said rupture piston ruptures said burst seal;
whereby with said burst seal ruptured, said piston aperture and said venting aperture are in communication so as to enable fluid flow through said venting aperture and said piston aperture.

18. The method according to claim 17, wherein:
said actuator is an explosive actuator.

19. The method according to claim 17, wherein:
said actuator is not a DOT-classified explosive device.

20. The method according to claim 17, wherein:
said rupture piston comprises a leading edge, said leading edge having a cross shape with said piston apertures defined in quadrants thereof.

21. The method according to claim 17, wherein:
said rupture piston comprises a leading edge, said leading edge having a ring shape said piston aperture defined in a center thereof.

22. The method according to claim 17, wherein:
fluid venting from said venting aperture begins within 25 milliseconds of initiation of said method.

23. The method according to claim 12, wherein:
fluid venting from said venting aperture begins within 10 milliseconds of initiation of said method.

24. The method according to claim 12, wherein:
fluid venting from said venting aperture begins within 5 milliseconds of initiation of said method.
